(19) United States
(12) Patent Application Publication
(10) Pub. No.: US 2018/0338440 A1
(43) Pub. Date: Nov. 29, 2018

(54) Cloner

(71) Applicant: Robert Dearinger, Seattle, WA (US)

(72) Inventor: Robert Dearinger, Seattle, WA (US)

(21) Appl. No.: 15/607,463

(22) Filed: May 27, 2017

(51) Int. Cl. A01G 31/06; A01G 27/02; A01G 13/08; A01G 9/10

(52) U.S. Cl. CPC A01G 31/06; A01G 27/02; A01G 31/02; A01G 9/1066; A01G 13/08

(57) ABSTRACT

A cloner may include a reservoir to hold a liquid, a lid with apertures to hold plant cuttings, stems, or roots, and a manifold mountable at or near a water line of the reservoir. One end of the lid may include a fan housing, and an opposite end may include ventilation holes. The reservoir may have a pump housing to hold a pump so that the pump does not become submerged in water, mitigating or preventing excess heat inside the cloner.

### FIELD

This disclosure relates generally to a cloner.

### BACKGROUND

Plant propagation or cloning may be achieved by a process called aeroponics. Aeroponics may involve growing plants in a chamber by misting suspended roots, without use of an aggregate medium such as soil. Aeroponics may improve oxygen and nutrient intake of roots, reduce water usage, and allow for higher density growing. Conventional cloners, for example, those with submersible water pumps, may generate excess heat inside the cloner, causing roots to rot. Fan systems on conventional cloners may fail to provide sufficient oxygen to roots or effective airflow to counter excess heat.

### SUMMARY

The following presents a simplified summary of the disclosure to provide a basic understanding to the reader. This summary is not an extensive overview of the disclosure, nor does it identify key or critical elements of the claimed subject matter or define its scope. Its sole purpose is to present some concepts disclosed in a simplified form as a precursor to the more detailed description that is later presented.

The instant application discloses, among other things, a cloner, which may use aeroponics to propagate or clone plants. In one embodiment, the cloner may comprise a reservoir operable to hold a liquid, such as water. The reservoir may include a housing to contain a pump. The pump may function without becoming submerged in the liquid. The pump housing may serve as a heat shield to mitigate or prevent harmful overheating inside the cloner.

The cloner may comprise a lid with apertures operable for holding plant cuttings, stems, or roots, for example. The lid may include a housing for a fan, which may direct airflow across the cloner to prevent an inside temperature from getting too hot. Airflow from the fan may mix with water sprayed from a manifold to diffuse dissolved oxygen to roots. The manifold may be mounted at or near a water line of the reservoir. A spoiler inside the lid may help direct air to flow efficiently across the cloner unit. Air may be released through ventilation holes in the reservoir, which may be located at an opposite end from the fan.

A person skilled in the art will understand that cloner and its components may comprise various shapes, colors, and sizes. Cloner may be made of a material such as plastic, carbon fiber, metal rubber, wood, or fiberglass, for example.

Many of the attendant features may be more readily appreciated as they become better understood by reference to the following detailed description considered in connection with the attached drawings.

### BRIEF DESCRIPTION OF THE DRAWINGS

FIG. 1 illustrates a perspective view of a cloner, according to one embodiment.

FIG. 2 illustrates a perspective front view of a cloner, according to one embodiment.

FIG. 3 illustrates a perspective rear view of a cloner, according to one embodiment.

FIG. 4 illustrates a bottom view of a cloner lid, according to one embodiment.

FIG. 5 illustrates a perspective view of an interior of a cloner reservoir, according to one embodiment.

FIG. 6 illustrates a perspective view of a manifold placed in an interior of a cloner reservoir, according to one embodiment.

FIG. 7 illustrates a perspective top view of a manifold, according to one embodiment.

FIG. 8 illustrates a perspective bottom view of a manifold, according to one embodiment.

FIG. 9 illustrates an exploded view of a cloner, including a lid, manifold, and reservoir, among other features, according to one embodiment.

FIG. 10 illustrates a bottom view of a cloner reservoir, according to one embodiment.

Like reference numerals are used to designate like parts in the accompanying drawings.

### DETAILED DESCRIPTION

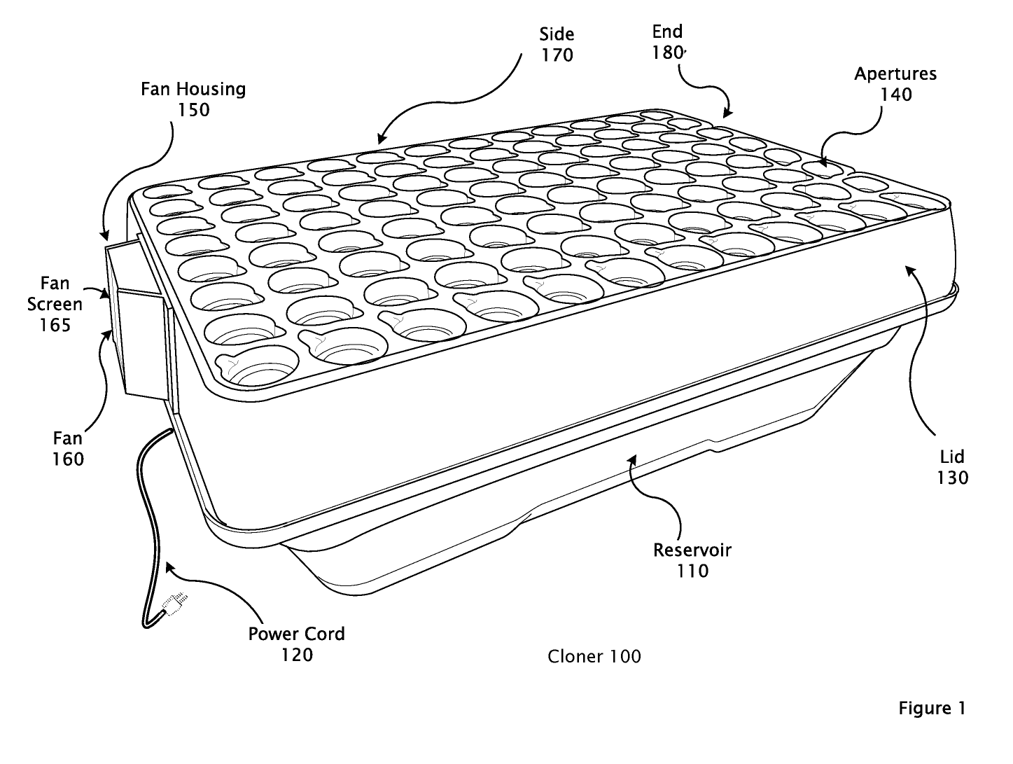

FIG. 1 illustrates a perspective view of Cloner 100, according to one embodiment. Cloner 100 may comprise a Reservoir 110 operable to hold a liquid such as water. The liquid may be tap water, filtered water, reverse osmosis water, or another composition, for example. Reservoir 110 may include a Pump Housing 210, which may receive electrical power through Power Cord 120. In another embodiment, Cloner 100 or its components may receive battery power, or solar power, for example. Reservoir 110 may be rectangular, and configured with Side 170 longer than End 180.

Cloner 100 may comprise a Lid 130 with Apertures 140 across its surface. Apertures 140 may serve as sites for holding plant cuttings, stems, or roots, for example. Stem collars, neoprene inserts, or other accessories may be placed in Apertures 140 to promote stability or nourishment of objects in Apertures 140.

Lid 130 may include Fan Housing 150 to house Fan 160. Fan Screen 165 may couple to Fan Housing 150, covering an outward-facing side of Fan 160. Fan Screen 165 may comprise a clear polymer film with holes, for example, to block obstructions from entering Fan 160 or promote user safety, while allowing passage of air.

Fan 160 may move a fluid, such as cool air, into Cloner 100. The air may be directed to flow across Cloner 100 to prevent an inside temperature from getting too high, to promote air or water circulation, or to optimize diffusion of dissolved oxygen, for example.

In one embodiment, Fan 160 may be located at a first end of a generally rectangular-shaped Reservoir 110. A spoiler inside of Lid 130 may direct air moved by Fan 160 to flow toward the sides of an interior space of Cloner 100, causing the air to flow efficiently across a length of Cloner 100. Air may be released from Cloner 100 through ventilation holes on a second end of Lid 130, opposite Fan 160, for example.

Air flow generated by Fan 160 may mix with water sprayed from a manifold in Reservoir 110 to diffuse dissolved oxygen to roots, for example. In another embodiment, the air may be directed to create turbulent air flow to optimize concentration or diffusion of dissolved oxygen, for example.

A person skilled in the art will understand that Cloner 100 and its components may comprise various shapes, colors, and sizes. For example, Cloner 100 may have a spherical shape in another embodiment. Cloner 100 may be made of a material including polymers such as plastic, composites such as carbon fiber or fiberglass, metal, rubber, or wood, for example.

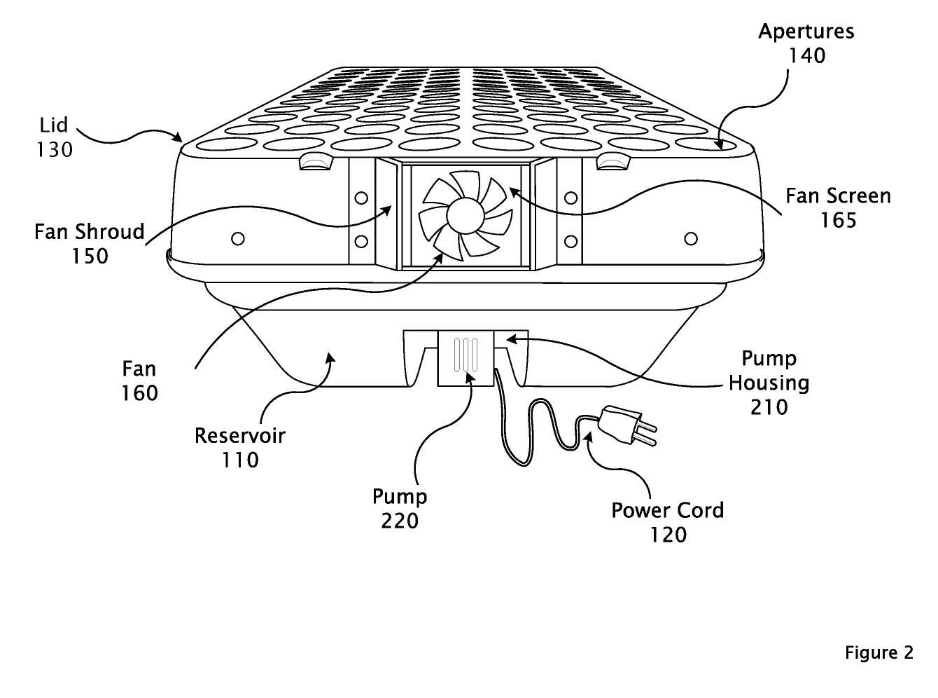

FIG. 2 illustrates a perspective front view of Cloner 100, according to one embodiment. Reservoir 110 may hold a liquid, for example, water, which may be mixed with plant nutrients or other matter. The liquid may have an optimal condition for propagating or cloning plants, for example, temperature or pH level. Cloner 100 or its components, for example, Pump 220 or Fan 160, may receive power through Power Cord 120.

Reservoir 110 may include Pump Housing 210, operable to receive Pump 220. Pump Housing 210 may receive Pump 220 in such a way that Pump 220 is situated separately or externally from an interior space of Reservoir 110, for example, preventing Pump 220 from coming into contact or becoming submerged in the liquid of Reservoir 110. Pump 220 may be operable to move a fluid, for example, water, through piping connected to a manifold with spray jets. Pump 220 may operate without becoming submerged in the liquid of Reservoir 110. Submersible pumps may create excess heat within a cloner. Pump Housing 210 may serve as a heat shield to mitigate or prevent heat which may be incidentally generated by Pump 220 from overheating the inside of Cloner 100, for example.

A surface of Lid 130 may have Apertures 140 for holding plant cuttings, stems, or roots, for example. A first end of Lid 130 may include Fan Housing 150 for receiving Fan 160. A protective Fan Screen 165 may couple to Fan Housing 150, covering an outward-facing side of Fan 160. Fan Screen 165 may have holes to allow air to pass through it.

In one embodiment, Fan Housing 150 or Fan 160 may couple to a light, for example, a light-emitting diode (LED). The LED may have various attributes such as color, brightness, or flash, for example. The LED may indicate information, for example, a type of plant being grown, a stage in a growing process, or an environmental condition inside or outside Cloner 100, such as temperature, pH level, or humidity. In another embodiment, the LED may be used to indicate that a Cloner 100 unit is in operation, to identify an inventory of a Cloner 100 unit, or identify clone strains by a color of the LED, for example. Use of an LED with Fan Housing 150 or Fan 160 may give Cloner 100 a unique style or individuality. In another embodiment, an LED may identify a Cloner 100 product brand or model, for example.

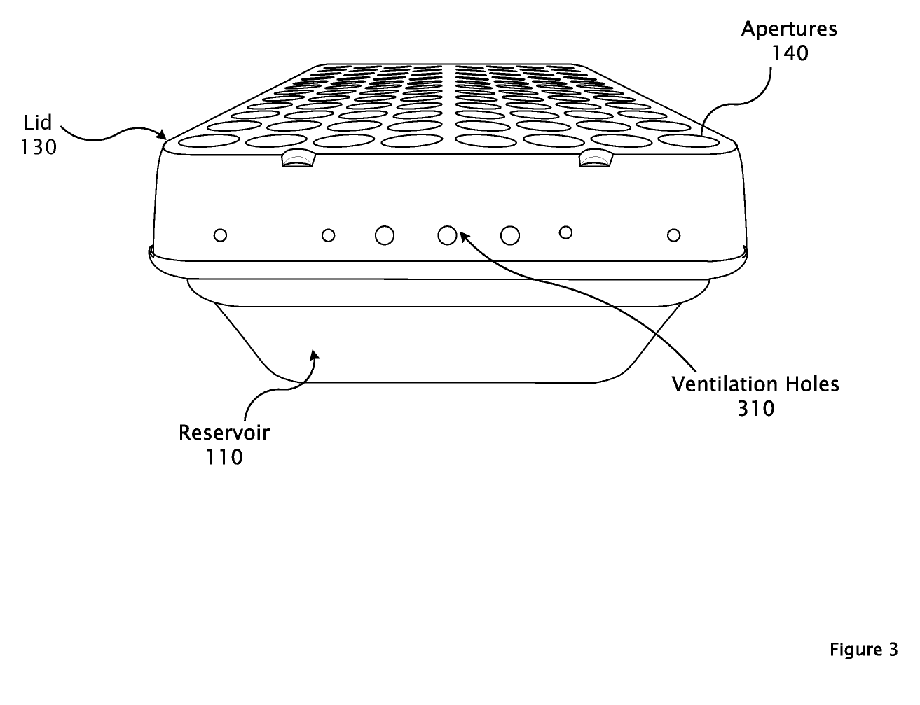

FIG. 3 illustrates a perspective rear view of Cloner 100, according to one embodiment. Reservoir 110 may hold a liquid such as water and may couple to Lid 130. Lid 130 may have a plurality of Apertures 140 for holding plant cuttings, stems or roots, for example. Air moved by a fan on a first end of Lid 130 may be released through Ventilation Holes 310, which may be located at an opposite end of Lid 130 in relation to the fan.

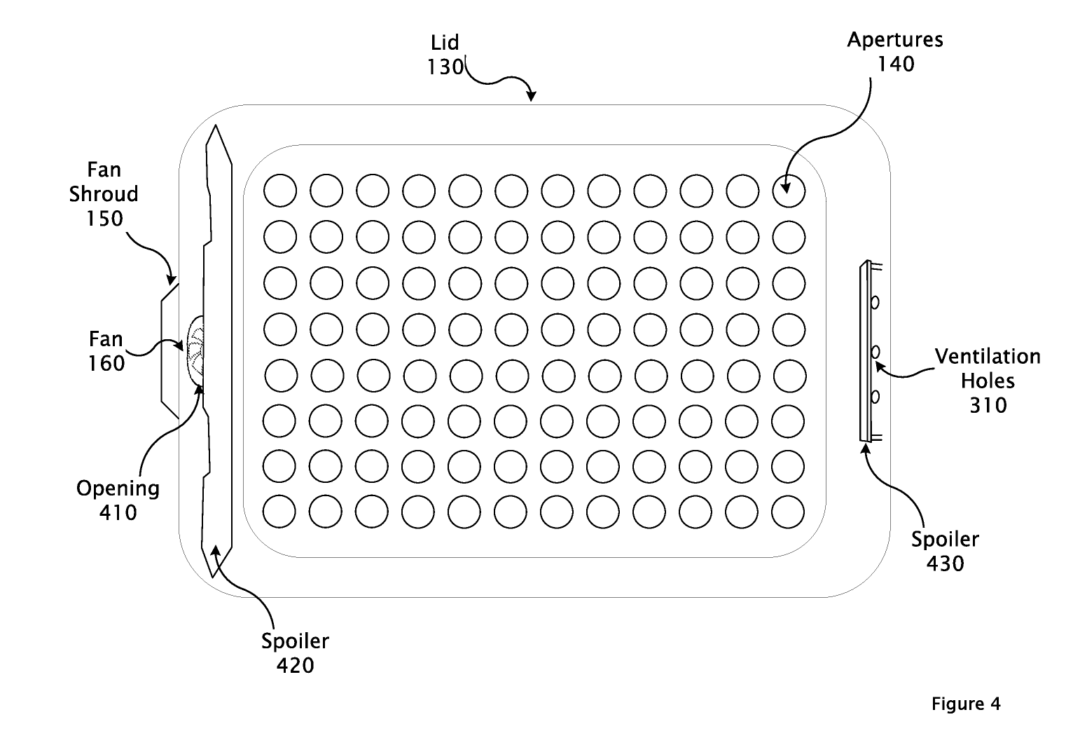

FIG. 4 illustrates a bottom view of Lid 130, according to one embodiment. This example shows an underside interior view of Lid 130. Lid 130 may have Apertures 140 for holding plant cuttings, stems, or roots, for example. At a first end of Lid 130, a Fan Housing 150 may house Fan 160. Air moved into the Cloner 100 by Fan 160 may flow through Opening 410 and reach Spoiler 420, which may direct the air to flow toward the distal ends of Spoiler 420 and generally along the sides of an interior space of Cloner 100, creating an efficient flow of air across a length of Cloner 100. A bottom surface of Spoiler 420 may hit at or near a water line of Reservoir 110.

Air may be released through Ventilation Holes 310 at a second end of Lid 130, on a side opposite from Fan 160. A second Spoiler 430 may be located in front of Ventilation Holes 310 to prevent air from being released too quickly from Cloner 100 or to minimize or prevent outside air from entering Cloner 100. Spoiler 430 may be smaller in size than Spoiler 420.

Air flow from Fan 160 may mix with water sprayed from a manifold in Reservoir 110 to diffuse dissolved oxygen to roots. In one embodiment, Fan 160 and Spoiler 430 may help create turbulence within Cloner 100 to increase a concentration of dissolved oxygen, for example.

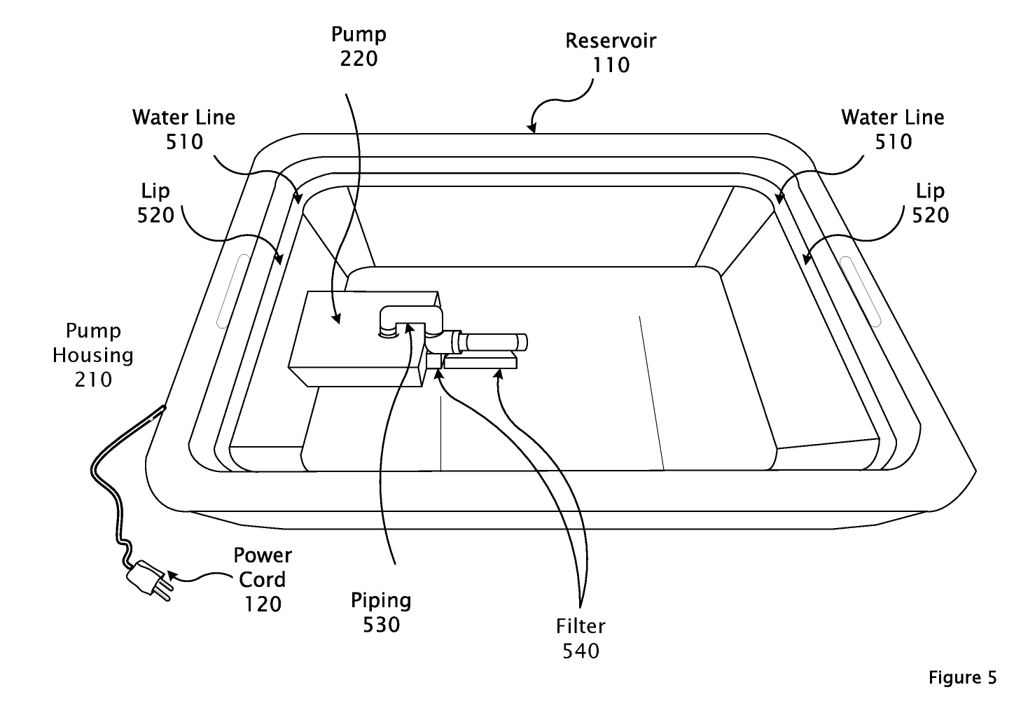

FIG. 5 illustrates a perspective view of an interior of Reservoir 110, according to one embodiment. Reservoir 110 may hold liquid, such as water, up to Water Line 510, for example. Lip 520 may be located at or near Water Line 510, and may serve as a mounting surface for a manifold equipped with spray jets. Reservoir 110 may include Pump Housing 210, operable to receive Pump 220. Pump Housing 210 may receive Pump 220 in such a way that Pump 220 is situated separately or externally from an interior space of Reservoir 110, for example, preventing Pump 220 from coming into contact or becoming submerged in the liquid of Reservoir 110. Cloner 100 or its components, for example, a fan, light, or Pump 220, may receive power through Power Cord 120.

Pump 220 may be operable to push a fluid, for example, water, through Piping 530, which may couple to a manifold equipped with spray jets. Filter 540 may comprise a water filter for Pump 220. Pump 220 may operate without becoming submerged in the liquid of Reservoir 110. Pump Housing 210 may serve as a heat shield to mitigate or prevent harmful overheating inside Cloner 100, for example.

Cloner 100 may be drained by connecting a hose to Piping 630, turning on Pump 220, and utilizing the pump to allow the liquid to drain out of Reservoir 110 and into a bucket placed below Cloner 100, for example. In another embodiment, Cloner 100 may have a drain, for example, in Reservoir 110.

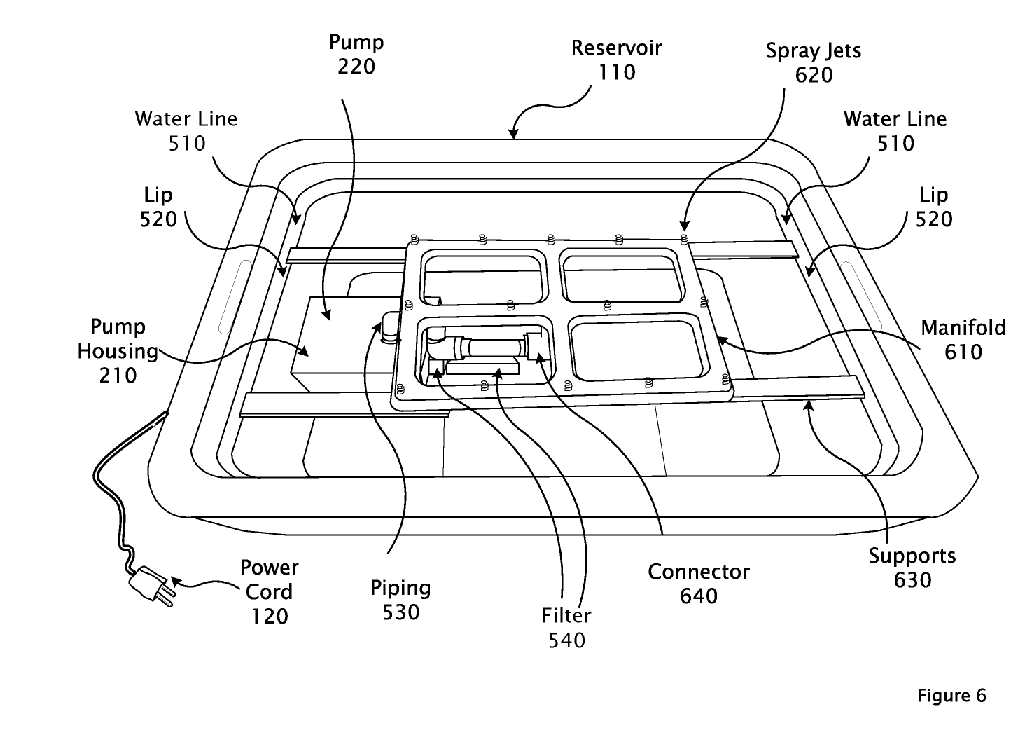

FIG. 6 illustrates a perspective view of Manifold 610 placed in an interior of Reservoir 110, according to one embodiment. Reservoir 110 may hold a liquid, such as water, up to Water Line 510. Cloner 100 or its components may receive power from Power Cord 120. Reservoir 110 may include Pump Housing 210, which may receive Pump 220. Pump Housing 210 may receive Pump 220 in such a way that Pump 220 is situated separately or externally from an interior space of Reservoir 110, for example, preventing Pump 220 from coming into contact or becoming submerged in the liquid of Reservoir 110.

Lip 520 may be located at or near Water Line 510 and may serve as a mounting surface for a Manifold 610.

Manifold 610 may include a plurality of Spray Jets 620 for diffusing water and dissolved oxygen, for example, inside Cloner 100. Manifold 610 may have Supports 630 which may rest upon Lip 520, allowing Manifold 610 to remain at or near Water Line 510 and to maintain a flat or stable position.

Pump 220 may push a fluid, for example, water, through an arrangement of Piping 530 which may connect to a manifold with spray jets. Filter 540 may comprise a water filter for Pump 220. Connector 640 may couple Manifold 610 to Piping 530. Pump 220 may operate without becoming submerged in the liquid of Reservoir 110. Submersible pumps may create excess heat within a cloner. Pump Housing 210 may serve as a heat shield to mitigate or prevent heat created by Pump 220 from overheating the inside of Cloner 100.

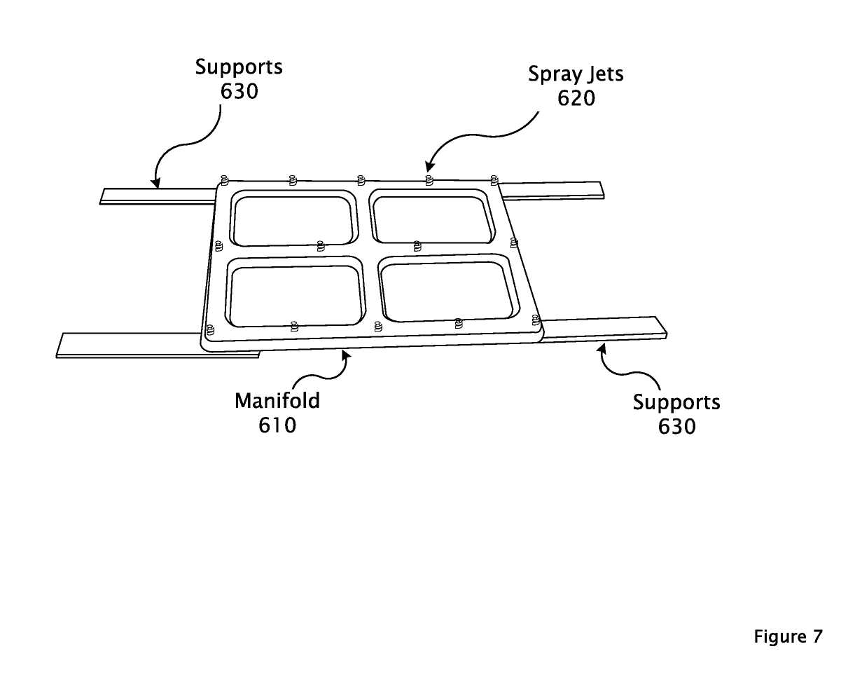

FIG. 7 illustrates a perspective top view of a manifold, according to one embodiment. Manifold 610 may couple to the piping system of Cloner 100. Manifold 610 may have a plurality of Spray Jets 620, which may release a liquid such as water. Air flow moved by the fan may mix with water released from the Spray Jets 620 of Manifold 610 to diffuse dissolved oxygen, nourishing the roots, for example. Manifold 610 may have Supports 630 to mount Manifold onto lips of the reservoir.

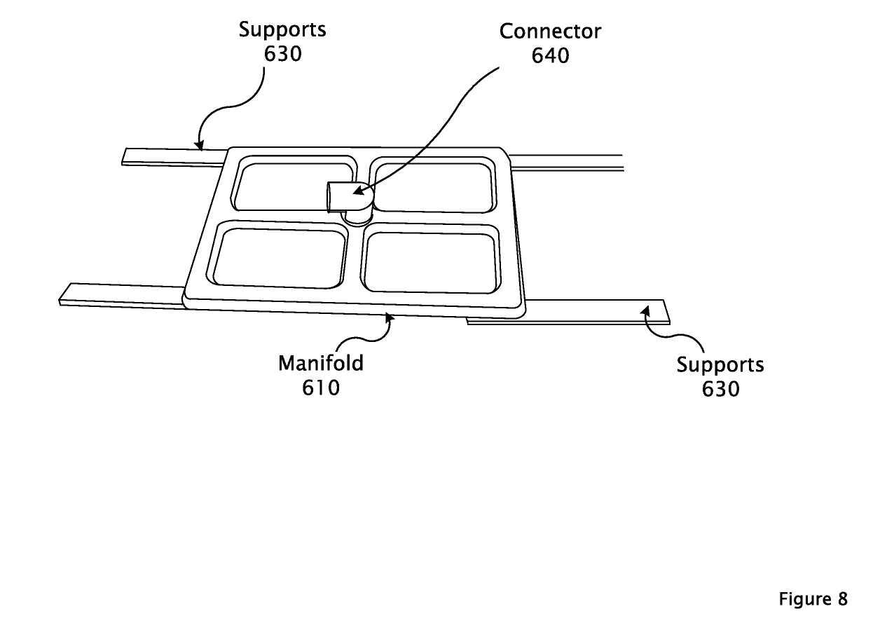

FIG. 8 illustrates a perspective bottom view of a manifold, according to one embodiment. Manifold 610 may couple to the piping system of Cloner 100. Manifold 610 may have spray jets to release a liquid, for example, water. Manifold 610 may have Supports 630 to allow Manifold 610 to rest or mount onto the lips of the reservoir, keeping Manifold 610 flat and at or near the water line. Connector 640 may couple Manifold 610 to the piping system of Cloner 100.

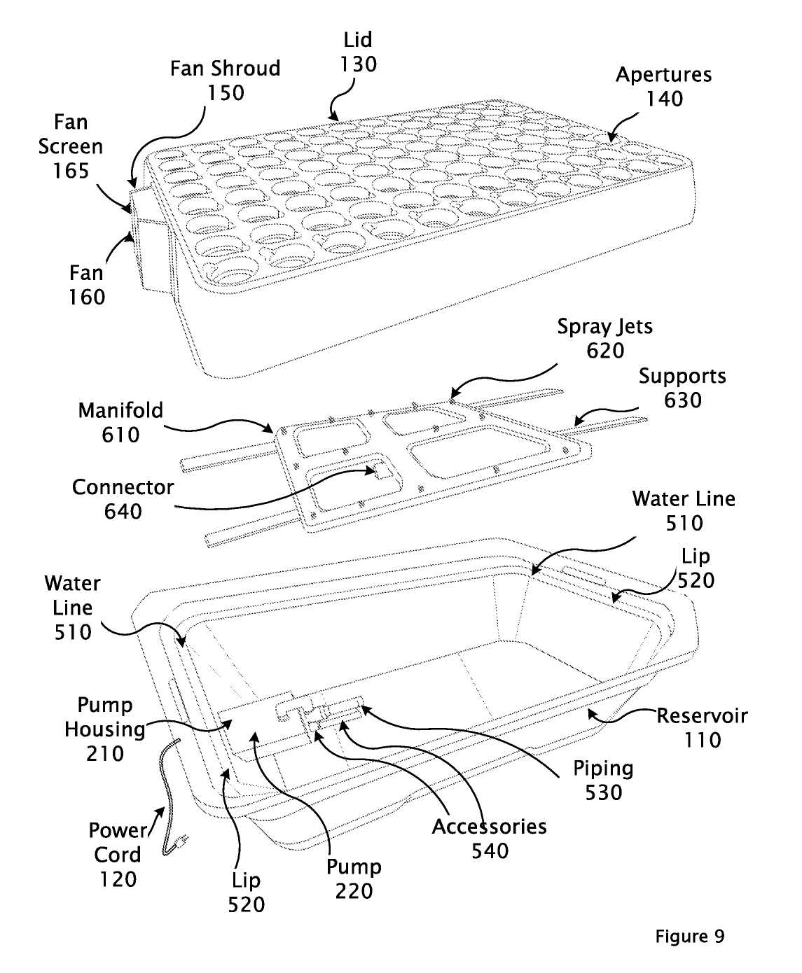

FIG. 9 illustrates an exploded view of Cloner 100, including a lid, manifold, and reservoir, among other features, according to one embodiment. Reservoir 110 may serve as a base portion of Cloner 100. Reservoir 110 may include Pump Housing 210, operable to receive Pump 220. Pump Housing 210 may receive Pump 220 in such a way that Pump 220 is situated separately or externally from an interior space of Reservoir 110, for example, preventing Pump 220 from coming into contact or becoming submerged in the liquid of Reservoir 110.

Pump 220 may couple to Piping 530, and Filter 540 may comprise a water filter for Pump 220. Water may fill Reservoir 110 up to or near Water Line 510. Lip 520 may be located at or near Water Line 520. A surface of Lip 520 may serve as a mounting surface for the manifold. Cloner 100 may receive power through a Power Cord 120, for example.

Manifold 610 may be stacked onto Reservoir 110 by resting or mounting Supports 630 on Lip 520 of Reservoir 110. Spray Jets 620 may release liquid, such as water into Cloner 100 in any direction, for example upward, sideways, or in a rotation. Spray Jets 620 may include threaded sockets for stability or easy removal. Connector 640 may couple an underside of Manifold 610 to Piping 530.

Lid 130 may comprise a top portion of Cloner 100. Lid 310 may be placed on top of Reservoir 110 to enclose Cloner 100. A locking mechanism or other enclosure means may prevent Lid 130 from sliding off. Lid 130 may have Apertures 140 for holding plant cuttings, stems, or roots. Accessories, for example, stem collars or neoprene inserts may be inserted into or within Apertures 140.

Lid 130 may have a Fan Housing 150 at one end. Fan Housing may house Fan 160, which may move a fluid, for example, cool air, into Cloner 100. Fan Screen 165 may couple to Fan Housing 150 or Fan 160 to prevent objects from obstructing Fan 160.

Cloner 100 may be placed on a flat surface, such as a floor or table, to optimize effectiveness in propagating or cloning plants, for example. Cloner 100 may also couple with a lighting fixture, to facilitate in the growing process. In one embodiment, it may be placed on a cart having a flat surface for receiving Cloner 100. The cart may include a multi-plug device for receiving multiple power plugs, for example, plugs from Fan 160 or Pump 220. The cart may also include a light fixture, for example, a fluorescent grow light, which may be mounted above Cloner 100.

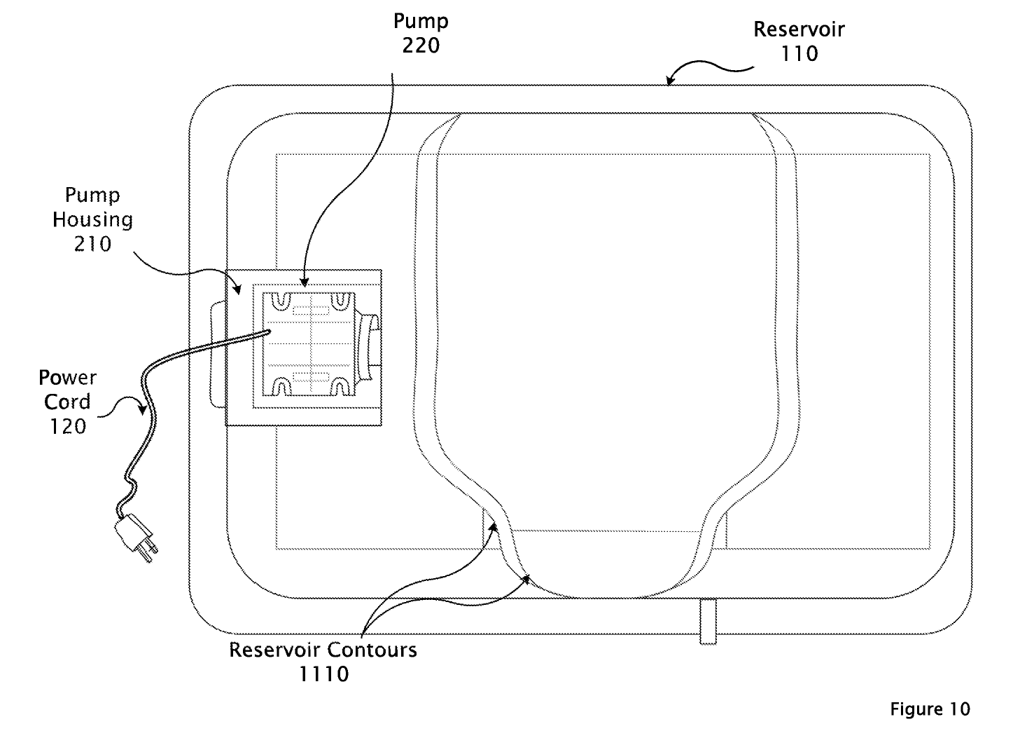

FIG. 10 illustrates a bottom view of Reservoir 110, according to one embodiment. Reservoir 110 may have a plurality of Reservoir Contours 1110. Reservoir 110 may include Pump Housing 210 to receive Pump 220. Pump Housing 210 may receive Pump 220 in such a way that Pump 220 is situated separately or externally from an interior space of Reservoir 110, for example, preventing Pump 220 from coming into contact or becoming submerged in the liquid of Reservoir 110. Cloner 100 or its components, for example, Pump 220, may receive power from Power Cord 120.

1. A cloner, comprising:
a reservoir, the reservoir operable to hold a liquid;
a pump housing, the pump housing coupled to the reservoir;
a pump, the pump disposed within the pump housing;
a manifold, the manifold coupled to the reservoir;
a lid, the lid removably coupled to the reservoir;
a fan housing, the fan housing coupled to a first end of the lid;
a fan, disposed within the fan housing;
a plurality of apertures in the reservoir, the apertures operable to allow release of air; and
a power source, operably coupled to the pump and the fan.

2. The pump housing of claim 1, further operable to prevent the pump from becoming submerged in liquid.

3. The pump housing of claim 1, further operable to prevent heat generated by the pump from overheating an interior space of the cloner.

4. The lid of claim 1, wherein the lid includes a plurality of apertures.

5. The fan housing of claim 1, wherein the fan housing is operable to receive a light.

6. The fan of claim 1, wherein the fan is operable to receive a light.

7. The fan housing of claim 1, wherein the fan housing is operable to receive a light-emitting diode (LED).

8. The fan of claim 1, wherein the fan is operable to receive a light-emitting diode (LED).

9. The manifold of claim 1, further comprising a plurality of spray jets.

10. The manifold of claim 9, wherein the plurality of spray jets are operable to release a liquid.

11. The manifold of claim 9, wherein the plurality of spray jets have threaded sockets.
